(19) United States
(12) Patent Application Publication
(10) Pub. No.: US 2026/0010119 A1
(43) Pub. Date: Jan. 8, 2026

(54) IMAGE FORMING SYSTEM

(71) Applicant: FUJIFILM Business Innovation Corp., Tokyo (JP)

(72) Inventor: Yosuke KASUYA, Kanagawa (JP)

(73) Assignee: FUJIFILM Business Innovation Corp., Tokyo (JP)

(21) Appl. No.: 19/050,380

(22) Filed: Feb. 11, 2025

(30) Foreign Application Priority Data
Jul. 4, 2024 (JP) 2024-108411

(51) Int. Cl. G03G 21/20; G03G 15/02; G03G 15/04; G03G 15/095

(52) U.S. Cl. CPC G03G 21/206; G03G 15/0291; G03G 15/04054; G03G 15/095; G03G 2215/027; G03G 2215/0621; G03G 2221/163

(57) ABSTRACT

An image forming system includes: a rotatable image carrier; a charger that is disposed to be opposed to the image carrier, and configured to charge a surface of the image carrier; a light exposer that is disposed to be opposed to the image carrier downstream of the charger in a rotational direction of the image carrier, and configured to expose the image carrier by transmitting light through multiple lenses arranged in an axial direction of the image carrier to form a latent image on the image carrier, the light being emitted from multiple light emitting elements; and a first ventilation pipe that is provided between the charger and the light exposer to construct part of an in-pipe wall surface at a lateral surface of the light exposer, and configured to allow air to pass through the first ventilation pipe, the lateral surface closer to the charger.

### CROSS-REFERENCE TO RELATED APPLICATIONS

This application is based on and claims priority under 35 USC 119 from Japanese Patent Application No. 2024-108411 filed Jul. 4, 2024.

### BACKGROUND

### (i) Technical Field

The present disclosure relates to an image forming system.

### (ii) Related Art

Japanese Unexamined Patent Application Publication No. 2011-85852 discloses an image forming apparatus including a photoconductor, a charger, a light exposer, and an air supply and exhaust mechanism. The photoconductor forms an electrostatic latent image. The charger charges the surface of the photoconductor using corona discharge. The light exposer exposes the surface of the photoconductor using an LED head whose electrode is bonded to an electrode of a substrate via an adhesive. The air supply and exhaust mechanism forms a path for communication between the charger and the light exposer and for air containing the ozone between the charger and the light exposer. The air supply and exhaust mechanism includes an air flow generator that generates a flow of the air from the light exposer to the charger.

Japanese Unexamined Patent Application Publication No. 2003-345199 discloses an image forming apparatus including an image forming member for forming an image, the image forming member being configured to produce substances to be removed and exhausted to the outside with air in connection with an image forming operation. In the image forming apparatus, the image forming member is provided with an air intake unit that can intake air, and an air exhaust unit that can exhaust, from the image forming member with air, substances to be removed, then an air intake port for the air intake unit, and an air exhaust port for the air exhaust unit are disposed adjacent to each other in the vicinity of the image forming member.

Japanese Unexamined Patent Application Publication No. 2009-86136 discloses an electrophotographic image forming apparatus that exposes a rotating photoconductor by a print head in which a plurality of point light sources are arranged. The image forming apparatus includes a first sheet, a second sheet, and a suction unit. The first sheet is provided upstream of the print head in the rotational direction of the photoconductor, and slides along the photoconductor. The second sheet is provided downstream of the first sheet in the rotational direction of the photoconductor, and slides along the photoconductor. The suction unit sucks the air between the first and second sheets.

### SUMMARY

Aspects of non-limiting embodiments of the present disclosure relate to providing an image forming system that can cool a light exposer with reduced layout space, as compared to when a ventilation pipe exclusively for cooling the light exposer is provided.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming system including: a rotatable image carrier; a charger that is disposed to be opposed to the image carrier, and configured to charge a surface of the image carrier; a light exposer that is disposed to be opposed to the image carrier downstream of the charger in a rotational direction of the image carrier, and configured to expose the image carrier by transmitting light through a plurality of lenses arranged in an axial direction of the image carrier to form a latent image on the image carrier, the light being emitted from a plurality of light emitting elements; and a first ventilation pipe that is provided between the charger and the light exposer to construct part of an in-pipe wall surface at a lateral surface of the light exposer, and configured to allow air to pass through the first ventilation pipe, the lateral surface closer to the charger.

### BRIEF DESCRIPTION OF THE DRAWINGS

Exemplary embodiments of the present disclosure will be described in detail based on the following figures, wherein:

FIG. 1 is a schematic front view illustrating the configuration of an image forming system according to a first exemplary embodiment;

FIG. 2 is a schematic configuration view illustrating a toner image former of the image forming system according to the first exemplary embodiment;

FIG. 3 is a schematic side view of a first duct of the image forming system according to the first exemplary embodiment, the view in a direction crossing the axial direction of a photoconductor drum;

FIG. 4 is a schematic configuration view illustrating a toner image former of an image forming system according to a second exemplary embodiment;

FIG. 5 is a schematic configuration view illustrating a toner image former of an image forming system according to a third exemplary embodiment;

FIG. 6 is a schematic configuration view illustrating a toner image former of an image forming system according to a fourth exemplary embodiment;

FIG. 7 is a schematic configuration view illustrating a toner image former of an image forming system of a first comparative example;

FIG. 8 is a schematic configuration view illustrating a toner image former of an image forming system of a second comparative example.

### DETAILED DESCRIPTION

Hereinafter, an example of an exemplary embodiment of the present disclosure will be described with reference to the drawings. In the following description, the direction indicated by an arrow W in the drawings is referred to as the apparatus width direction, and the direction indicated by an arrow H is referred to as the apparatus height direction. In addition, the direction (arrow D direction) perpendicular to each of the apparatus width direction and the apparatus height direction is referred to as the apparatus depth direction.

### First Embodiment

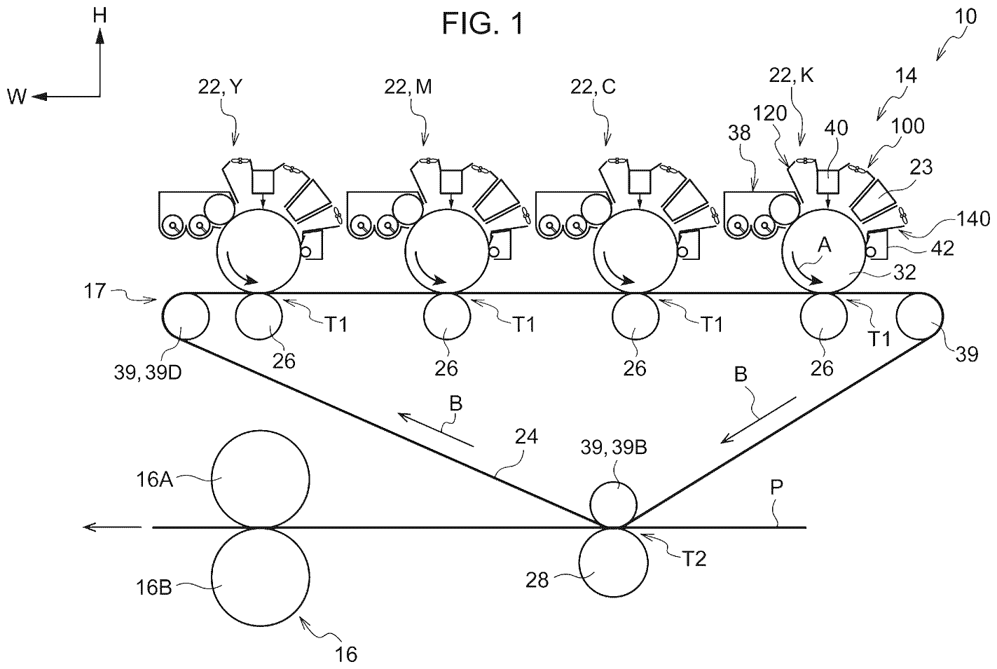

FIG. 1 illustrates an image forming system 10 according to a first exemplary embodiment. First, the entire configuration of the image forming system 10 (see FIG. 1) in the first exemplary embodiment will be described. Next, the main components of the image forming system 10 will be described.

### Entire Configuration of Image Forming System 10

As illustrated in FIG. 1, the image forming system 10 is an example of an image forming system that forms an image on a recording medium P. Specifically, the image forming system 10 is an electrophotographic image forming system that forms an image on the recording medium P. More specifically, the image forming system 10 includes an image former 14, and a fixing device 16. The image former 14 has a function of forming toner images having different colors on the recording medium P. Specifically, the image former 14 includes toner image formers 22, and a transfer device 17.

### Toner Image Former 22

As illustrated in FIG. 1, a plurality of toner image formers 22 are provided so as to form toner images for respective colors. In the first exemplary embodiment, the toner image formers 22 are provided for four colors in total: yellow (Y), magenta (M), cyan (C), and black (K). (Y), (M), (C), and (K) illustrated in FIG. 1 indicate the components corresponding to the respective colors.

Note that the toner image formers 22 for respective colors are similarly configured except for the toner to be used, thus each component of the toner image former 22 (K) representing the toner image formers 22 for respective colors is labeled with a symbol in FIG. 1.

The toner image former 22 of each color includes a photoconductor drum 32 that rotates in one direction (for example, an arrow A direction which is a counterclockwise direction in FIG. 1). The photoconductor drum 32 is an example of an image carrier. The toner image former 22 of each color further includes a charging device 23, an exposure device 40, a developing device 38, and a cleaning device 42. The charging device 23 is an example of a charger, the exposure device 40 is an example of an exposure, and the developing device 38 is an example of a developing unit. The toner image former 22 is an example of a plurality of image formers provided for different colors.

In the toner image former 22 of each color, the charging device 23 charges the surface of the photoconductor drum 32. In addition, the exposure device 40 exposes the photoconductor drum 32 charged by the charging device 23 to form an electrostatic latent image on the surface of the photoconductor drum 32. The electrostatic latent image is an example of a latent image. In addition, the developing device 38 uses toner to develop the electrostatic latent image formed on the surface of the photoconductor drum 32 by the exposure device 40, and forms a toner image. The cleaning device 42 removes the toner remaining on the surface of the photoconductor drum 32 after transfer of a toner image.

The specific configuration of each component of the toner image former 22 will be described below.

### Transfer Device 17

As illustrated in FIG. 1, the transfer device 17 is a device that transfers the toner image formed by the toner image former 22 onto the recording medium P. Specifically, the transfer device 17 first transfers toner images of the photoconductor drums 32 of respective colors on a transfer belt 24 as an intermediate transfer body in a superimposed manner, and second transfers the superimposed toner images to the recording medium P. The transfer belt 24 is an example of an intermediate transfer body. Specifically, as illustrated in FIG. 1, the transfer device 17 includes the transfer belt 24, first transfer rollers 26, and a second transfer roller 28.

Each first transfer roller 26 is a roller that transfer a toner image of the photoconductor drum 32 of a corresponding color to the transfer belt 24 at a first transfer position T1 between the photoconductor drum 32 and the first transfer roller 26. In the first exemplary embodiment, the toner image formed on the photoconductor drum 32 is transferred to the transfer belt 24 at the first transfer position T1 by applying a first transfer electric field across the first transfer roller 26 and the photoconductor drum 32.

Toner images from the photoconductor drums 32 of respective colors are transferred to the outer circumferential surface of the transfer belt 24. Specifically, the transfer belt 24 is configured in the following manner. As illustrated in FIG. 1, the transfer belt 24 is in a loop shape, and its posture is determined by a plurality of rollers 39 wound thereon.

The transfer belt 24 circumferentially rotates in an arrow B direction, for example, by a drive roller 39D which is rotationally driven by a driver (not illustrated), the drive roller 39D being among the plurality of rollers 39. A drive roller 39B illustrated in FIG. 1 among the plurality of rollers 39 is an opposing roller 39B opposed to the second transfer roller 28.

The second transfer roller 28 is a roller that transfers a toner image transferred to the transfer belt 24 onto the recording medium P at a second transfer position T2 between the opposing roller 39B and the second transfer roller 28. In the first exemplary embodiment, the toner image transferred to the transfer belt 24 is transferred onto the recording medium P at the second transfer position T2 by applying a second transfer electric field across the opposing roller 39B and the second transfer roller 28.

### Fixing Device 16

As illustrated in FIG. 1, the fixing device 16 is a device that fixes a toner image on the recording medium P, the toner image being transferred onto the recording medium P by the second transfer roller 28. Specifically, as illustrated in FIG. 1, the fixing device 16 includes a heating roller 16A as a heating member, and a pressure roller 16B as a pressure member. In the fixing device 16, the recording medium P is heated and pressurized by the heating roller 16A and the pressure roller 16B, and the toner image formed on the recording medium P is thereby fixed onto the recording medium P.

### Operation of Image Forming System 10

Next, the operation of the image forming system 10 will be described.

When the operation of the image forming system 10 is started, in the toner image former 22 of each color, the photoconductor drum 32 is charged by the charging device 23, the photoconductor drum 32 is exposed by the exposure device 40, and an electrostatic latent image is thereby formed on the surface of the photoconductor drum 32. In addition, the electrostatic latent image on the photoconductor drum 32 is developed as a toner image by the developing device 38. As a result, in the toner image former 22 of each color, a toner image of the color is formed on the surface of the photoconductor drum 32.

Subsequently, a voltage (a first transfer voltage) is applied from a power source (not illustrated) to the first transfer roller 26 of each color. The drive roller 39D causes the transfer belt 24 to circumferentially rotate in the arrow direction. As a result, toner images of respective colors are first transferred to the transfer belt 24 in a superimposed manner.

The recording medium P is transferred to the second transfer position T2 at the timing when the toner images of respective colors carried on the circumferentially rotating transfer belt 24 reach nip N1. The toner images of respective colors are second transferred to the recording medium P at the second transfer position T2 by applying a voltage (a second transfer voltage) from a power source (not illustrated) to the opposing roller 39B. The recording medium P is further transported to the fixing device 16. The toner images of respective colors are fixed onto the recording medium P by the fixing device 16, and an image is thereby formed on the recording medium P.

### Specific Configuration of Toner Image Former 22

Next, the specific configuration of the toner image former 22 serving as the main component of the image forming system 10 will be described.

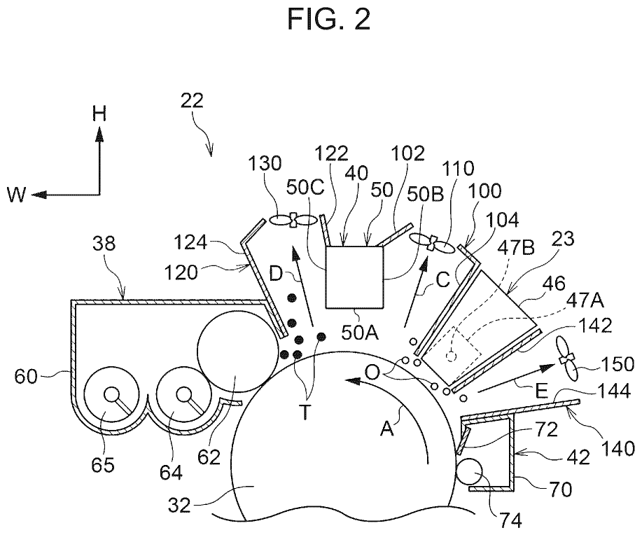

As illustrated in FIG. 2, the toner image former 22 includes the charging device 23, the exposure device 40, the developing device 38, and the cleaning device 42 around the photoconductor drum 32 as described above. Since each toner image former 22 has the same configuration except for the color of toner, the symbols Y, M, C, K for respective colors are omitted in FIG. 2. The toner image former 22 includes a first duct 100, a second duct 120, and a third duct 140.

### Charging Device 23

The charging device 23 is disposed to be opposed to the photoconductor drum 32. The charging device 23 is disposed to be spaced apart from the photoconductor drum 32. The charging device 23 is comprised of e.g., a corotron or scorotron. As an example, the charging device 23 includes a U-shaped shield 47A having an opening facing the photoconductor drum 32, and a wire 47B inside the shield 47A. The charging device 23 applies a high voltage to the wire 47B, thereby ionizing the air around the wire 47B to perform corona discharge. Thus, the surface of the photoconductor drum 32 is charged.

Ozone (O) is likely to be produced with the charging device 23 using this charging system. The ozone (O) causes contamination in the image forming system 10, thus needs to be exhausted. The exhaust of ozone (O) will be described later.

In FIG. 2, the shield 47A and the wire 47B are provided inside a housing 46 of the charging device 23. The housing 46 is schematically illustrated, and the shape of the housing 46 may be changed.

### Exposure Device 40

The exposure device 40 is disposed to be opposed to the photoconductor drum 32 downstream of the charging device 23 in the rotational direction of the photoconductor drum 32. The exposure device 40 is disposed to be spaced apart from the photoconductor drum 32. Although illustration is omitted, the exposure device 40 exposes the photoconductor drum 32 by transmitting light through a plurality of lenses arranged in the axial direction of the photoconductor drum 32, the light being emitted from a plurality of light emitting elements. Thus, an electrostatic latent image is formed on the surface of the photoconductor drum 32. As an example, the exposure device 40 is comprised of an LED print head including an LED which is an example of a light emitting element.

The exposure device 40 includes a rectangular housing 50. Although illustration is omitted, a surface 50A of the housing 50 is provided with a plurality of lenses through which light is transmitted, the surface 50A facing the photoconductor drum 32. In the exposure device 40, as compared to a scanning optical writing device that forms an electrostatic latent image by radiating a laser beam to the photoconductor drum 32, the photoconductor drum 32 is closer (in other words, the distance from the photoconductor drum 32 is shorter). The exposure device 40 has a lateral surface 50B of the housing 50 and a lateral surface 50C of the housing 50, the lateral surface 50B closer to the charging device 23, the lateral surface 50C closer to the developing device 38.

### Developing Device 38

The developing device 38 is disposed to be opposed to the photoconductor drum 32 downstream of the exposure device 40 in the rotational direction of the photoconductor drum 32. The developing device 38 includes a housing 60, a developing roller 62, and a plurality of (e.g., two) augers 64, 65. The housing 60 stores developer containing toner. The developing roller 62 holds and transports the developer to the photoconductor drum 32. The augers 64, 65 transport developer in axially opposite directions while stirring the developer. The developer stirred by the auger 65 is supplied to the developing roller 62.

In the developing device 38, cloud toner (T) due to spread of the toner is likely to occur in part of the developing roll 62, the part facing the photoconductor drum 32. Such cloud toner (T) causes contamination in the image forming system 10, thus needs to be exhausted. The exhaust of the cloud toner (T) will be described later.

### Cleaning Device 42

The cleaning device 42 is disposed downstream of the first transfer position T1 (see FIG. 1) and upstream of the charging device 23 in the rotational direction of the photoconductor drum 32. As an example, the cleaning device 42 includes a cleaning blade 72, and a cleaning roller 74 inside a housing 70. The cleaning blade 72, and the cleaning roller 74 come into contact with the surface of the photoconductor drum 32, thereby removing the toner remaining on the surface of the photoconductor drum 32.

### First Duct 100

As illustrated in FIG. 2, the first duct 100 is provided between the charging device 23 and the exposure device 40. The first duct 100 is an example of a first ventilation pipe, and has a function of allowing air to pass therethrough. The first duct 100 constructs part of the in-pipe wall surface at the lateral surface 50B, closer to the charging device 23, of the exposure device 40. A first fan 110 for exhausting air in a direction (arrow C direction) away from the photoconductor drum 32 is provided downstream in the ventilation direction of the first duct 100. The first fan 110 is an example of a first air blower.

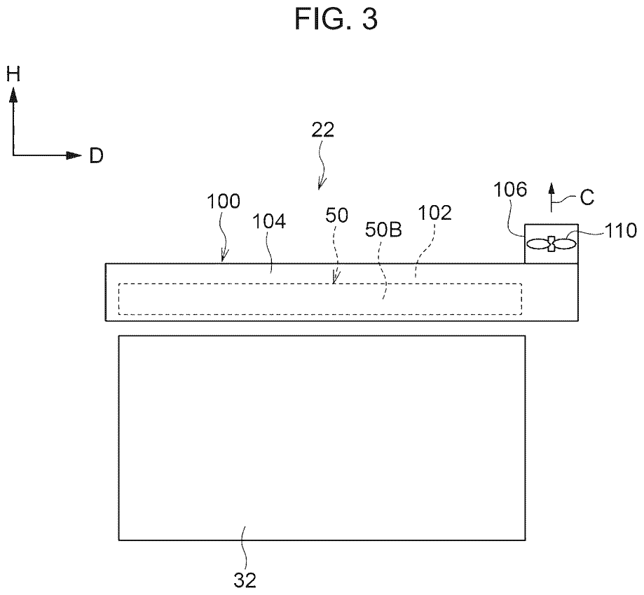

Specifically, the first duct 100 includes the lateral surface 50B of the housing 50 of the exposure device 40, and a rear wall section 102 extending from the lateral surface 50B in a direction away from the photoconductor drum 32. In addition, the first duct 100 includes a wall section 104 which is disposed to be connected to the lateral surface 50B and the rear wall section 102. In the cross-sectional view illustrated in FIG. 2, the first duct 100 is formed in a box shape by the lateral surface 50B, the rear wall section 102, and the wall section 104, and is open toward the photoconductor drum 32 (see FIG. 3). As an example, as illustrated in FIG. 2, the first duct 100 has a shape such that its inner diameter gradually increases in a direction away from the photoconductor drum 32, and starts to gradually decrease at a position just passing the housing 50 of the exposure device 40. Note that the shape of the first duct 100 is not limited to the shape illustrated in FIG. 2, and may be changed.

FIG. 3 is a side view illustrating the first duct 100, the view in a direction crossing the axial direction of the photoconductor drum 32. As illustrated in FIG. 3, the first duct 100 is disposed along the axial direction of the photoconductor drum 32. The lateral surface 50B and a rear wall section 122, and a wall section 124 illustrated in FIG. 2 are connected to the axial both ends of the photoconductor drum 32 on the back surface side with respect to the photoconductor drum 32. That is, in a cross-sectional view, the first duct 100 is formed in a U shape by the lateral surface 50B, the rear wall section 102, and the wall section 104, the U shape being open toward the photoconductor drum 32 (see FIG. 3). The axial length of the photoconductor drum 32 is longer than the longitudinal length of the first duct 100. One end of the first duct 100 in the axial direction of the photoconductor drum 32 is provided with a tubular wall section 106 that is disposed on the opposite side of the photoconductor drum 32 with respect to the first duct 100, and the wall section 106 is provided with the first fan 110. The rotation of the first fan 110 causes air to be exhausted in a direction (arrow C direction) away from the photoconductor drum 32. Thus, the ozone (O) generated from the charging device 23 is likely to be exhausted by the flow of air in the first duct 100.

### Second Duct 120

As illustrated in FIG. 2, the second duct 120 is provided between the developing device 38 and the exposure device 40. The second duct 120 is an example of a second ventilation pipe, and has a function of allowing air to pass therethrough. The second duct 120 constructs part of the in-pipe wall surface at the lateral surface 50C, closer to the developing device 38, of the exposure device 40. A second fan 130 for exhausting air in a direction (arrow D direction) away from the photoconductor drum 32 is provided downstream in the ventilation direction of the second duct 120. The second fan 130 is an example of a second air blower.

Specifically, the second duct 120 includes the lateral surface 50C of the housing 50 of the exposure device 40, and a rear wall section 122 extending from the lateral surface 50C in a direction away from the photoconductor drum 32. In addition, the second duct 120 includes a wall section 124 which is disposed to be connected to the lateral surface 50C and the rear wall section 122. In the cross-sectional view illustrated in FIG. 2, the second duct 120 is formed in a box shape by the lateral surface 50C, the rear wall section 122, and the wall section 124, and is open toward the photoconductor drum 32. As an example, as illustrated in FIG. 2, the second duct 120 has a shape such that its inner diameter gradually increases in a direction away from the photoconductor drum 32, and starts to gradually decrease at a position just passing the housing 50 of the exposure device 40. Note that the shape of the second duct 120 is not limited to the shape illustrated in FIG. 2, and may be changed.

The second duct 120 has a similar shape to that of the first duct 100 illustrated in FIG. 3 in a side view. Specifically, the second duct 120 is disposed along the axial direction of the photoconductor drum 32, and the longitudinal length of the second duct 120 is longer than the axial length of the photoconductor drum 32. In a cross-sectional view, the second duct 120 is formed in a U shape by the lateral surface 50C, the rear wall section 122, and the wall section 124, the U shape being open toward the photoconductor drum 32. As in FIG. 3, one end of the second duct 120 in the axial direction of the photoconductor drum 32 is provided with the second fan 130. The rotation of the second fan 130 causes air to be exhausted in a direction (arrow D direction) away from the photoconductor drum 32. Thus, the cloud toner (T) generated from the developing device 38 is likely to be exhausted by the flow of air in the second duct 120.

### Third Duct 140

As illustrated in FIG. 2, the third duct 140 is provided on the opposite side of the first duct 100 with respect to the charging device 23. The third duct 140 is an example of a third ventilation pipe, and has a function of allowing air to pass therethrough. The third duct 140 is provided between the charging device 23 and the cleaning device 42. In the cross-sectional view illustrated in FIG. 2, the third duct 140 includes wall sections 142, 144 open toward the photoconductor drum 32. Although illustration is omitted, the wall sections 142, 144 are connected at the axial both ends of the photoconductor drum 32. A fan 150 for exhausting air in a direction (arrow E direction) away from the photoconductor drum 32 is provided downstream in the ventilation direction of the third duct 140.

As an example, as illustrated in FIG. 2, the third duct 140 has a shape such that its inner diameter gradually increases in a direction away from the photoconductor drum 32. Note that the shape of the third duct 140 is not limited to the shape illustrated in FIG. 2, and may be changed.

The third duct 140 has a similar shape to that of the first duct 100 illustrated in FIG. 3 in a side view. The third duct 140 is disposed along the axial direction of the photoconductor drum 32, and the longitudinal length of the third duct 140 is longer than the axial length of the photoconductor drum 32. In a cross-sectional view, the third duct 140 is formed in a U shape by the wall sections 142, 144, the U shape being open toward the photoconductor drum 32. As in FIG. 3, one end of the third duct 140 in the axial direction of the photoconductor drum 32 is provided with the fan 150. The rotation of the fan 150 causes air to be exhausted in a direction (arrow E direction) away from the photoconductor drum 32. Thus, the ozone (O) generated from the charging device 23 is likely to be exhausted by the flow of air in the third duct 140.

### Image Forming System of First Comparative Example and Second Comparative Example

A toner image former in an image forming system of a first comparative example and a second comparative example will be described.

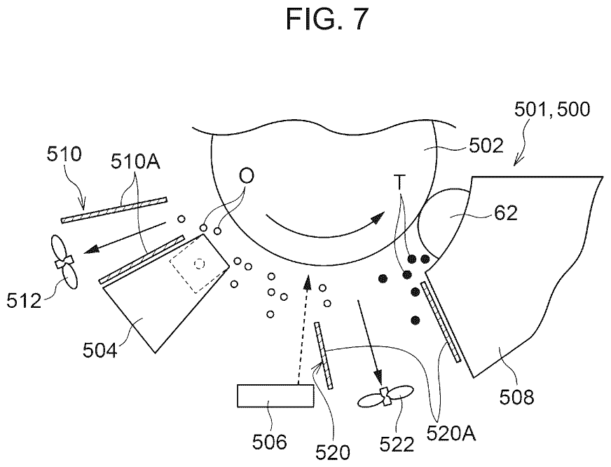

FIG. 7 illustrates a toner image former 501 of an image forming system 500 of a first comparative example. As illustrated in FIG. 7, the toner image former 501 includes a charging device 504, a writing device 506, and a developing device 508 around a photoconductor drum 502. Illustration of the cleaning device is omitted. The charging device 504 is comprised of a corotron. The writing device 506 is a scanning optical writing device that forms an electrostatic latent image by radiating a laser beam to the photoconductor drum 502. The image forming system 500 includes a duct 510 on the opposite side of the writing device 506 with respect to the charging device 504. In addition, the image forming system 500 includes a duct 520 between the writing device 506 and the developing device 508.

The duct 510 is disposed along the axial direction of the photoconductor drum 502. The duct 510 includes a wall section 510A open toward the photoconductor drum 502. A fan 512 for exhausting air in a direction away from the photoconductor drum 502 is provided downstream in the ventilation direction of the duct 510. The fan 512 is provided at one end of the duct 510 in the axial direction of the photoconductor drum 502. The ozone (O) generated from the charging device 504 is exhausted by the flow of air in the duct 510 caused by the rotation of the fan 512.

The duct 520 is disposed along the axial direction of the photoconductor drum 502. The duct 520 includes a wall section 520A open toward the photoconductor drum 502. A fan 522 for exhausting air in a direction away from the photoconductor drum 502 is provided downstream in the ventilation direction of the duct 520. The fan 522 is provided at one end of the duct 520 in the axial direction of the photoconductor drum 502. The cloud toner (T) generated from the developing device 508 is exhausted by the flow of air in the second duct 520 caused by the rotation of the fan 522.

In the toner image former 501, the distance between the writing device 506 and the photoconductor drum 502 is large. Thus, the duct 510 and the duct 520 are easily placed around the photoconductor drum 502.

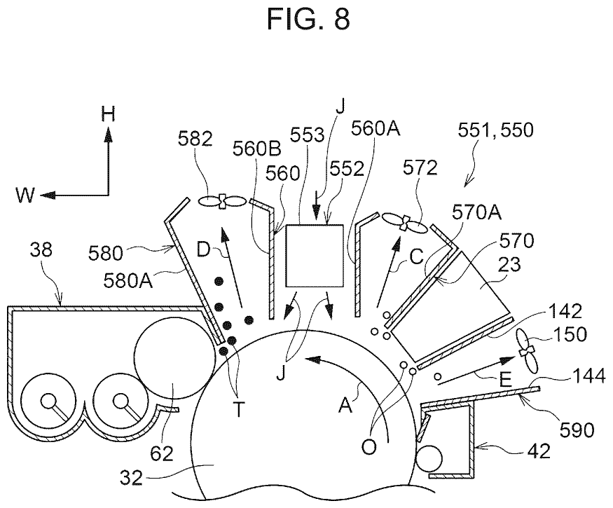

As illustrated in FIG. 8, a toner image former 551 of an image forming system 550 of the second comparative example includes an exposure device 552 comprised of an LED print head instead of the writing device 506 of the first comparative example. In the toner image former 551, the distance between the exposure device 552 and the photoconductor drum 32 is smaller than the distance between the writing device 506 and the photoconductor drum 502. Thus, the configuration to exhaust ozone (O) and toner (T) such as cloud toner needs to be changed. In the exposure device 552 comprised of an LED print head, light emitting elements are likely to generate heat, thus the exposure device 552 needs to be cooled.

The toner image former 551 includes the charging device 23, the developing device 38, and the cleaning device 42 in addition to the exposure device 552 around the photoconductor drum 32. A first duct 560 disposed at a position away from a housing 553 for the exposure device 552 is provided around the exposure device 552. A second duct 570 is provided between the exposure device 552 and the charging device 23. A third duct 580 is provided between the exposure device 552 and the developing device 38. A fourth duct 590 is provided between the charging device 23 and the cleaning device 42.

In the cross-sectional view illustrated in FIG. 8, the first duct 560 includes a pair of wall sections 560A and 560B. The pair of wall sections 560A and 560B are connected at the axial both ends of the photoconductor drum 32. The first duct 560 is disposed to surround the outside of the housing 553 for the exposure device 552.

In the cross-sectional view illustrated in FIG. 8, the second duct 570 includes a wall section 570A, and the wall section 560A which is common with the first duct 560. The wall section 570A and the wall section 560A are connected at the axial both ends of the photoconductor drum 32. A fan 572 for exhausting air in a direction (arrow C direction) away from the photoconductor drum 32 is provided downstream in the ventilation direction of the second duct 570.

In the cross-sectional view illustrated in FIG. 8, the third duct 580 includes a wall section 580A, and a wall section 560B which is common with the first duct 560. The wall section 580A and the wall section 560B are connected at the axial both ends of the photoconductor drum 32. A fan 582 for exhausting air in a direction (arrow D direction) away from the photoconductor drum 32 is provided downstream in the ventilation direction of the third duct 580.

The fourth duct 590 has the same configuration as that of the third duct 140 of the first exemplary embodiment.

In the toner image former 551, the rotation of the fan 572 causes air to be exhausted in the second duct 570 in a direction (arrow C direction) away from the photoconductor drum 32. The rotation of the fan 582 causes air to be exhausted in the third duct 580 in a direction (arrow D direction) away from the photoconductor drum 32. Thus, in the first duct 560, air flow is generated in a direction (arrow J direction) toward the photoconductor drum 32. Air which has passed through the first duct 560 hits the photoconductor drum 32, and diverges into the directions of the second duct 570 and the third duct 580. Thus, the diverging air is exhausted through the second duct 570 and the third duct 580.

In the image forming system 550 of the second comparative example, the second duct 570 for exhausting ozone (O) is provided between the exposure device 552 and the charging device 23, thus layout space is necessary. In addition, the third duct 580 for exhausting cloud toner (T) is provided between the exposure device 552 and the developing device 38, thus layout space is necessary. Furthermore, the first duct 560 exclusively for cooling the exposure device 552 is provided around the exposure device 552, thus layout space is necessary and accompanying cost increases.

### Operation of First Exemplary Embodiment

Next, the operation of the image forming system 10 of the first exemplary embodiment will be described.

The image forming system 10 includes the exposure device 40 which is disposed to be opposed to the photoconductor drum 32 downstream of the charging device 23. The exposure device 40 exposes the photoconductor drum 32 by transmitting light through a plurality of lenses arranged in the axial direction of the photoconductor drum 32, the light being emitted from a plurality of light emitting elements. Thus, an electrostatic latent image is formed on the photoconductor drum 32. The image forming system 10 includes the first duct 100 provided between the charging device 23 and the exposure device 40. The first duct 100 constructs part of the in-pipe wall surface at the lateral surface 50B, closer to the charging device 23, of the exposure device 40. Furthermore, the image forming system 10 includes the second duct 120 provided between the developing device 38 and the exposure device 40. The second duct 120 constructs part of the in-pipe wall surface at the lateral surface 50C, closer to the developing device 38, of the exposure device 40.

Thus, in the image forming system 10, as compared to when a ventilation pipe exclusively for cooling the exposure device is provided, the exposure device 40 can be cooled with reduced layout space.

In the image forming system 10, the first fan 110 for exhausting air in a direction away from the photoconductor drum 32 is provided downstream in the ventilation direction of the first duct 100. Thus, in the image forming system 10, the exposure device 40 can be cooled while exhausting the ozone (O) generated from the charging device 23 by the first fan 110 in the first duct 100.

In the image forming system 10, the second fan 130 for exhausting air in a direction away from the photoconductor drum 32 is provided downstream in the ventilation direction of the second duct 120. Thus, in the image forming system 10, the exposure device 40 can be cooled while exhausting the toner cloud (T) generated from the developing device 38 by the second fan 130 in the second duct 120.

In the image forming system 10, the third duct 140 for exhausting air in a direction away from the photoconductor drum 32 is provided on the opposite side of the first duct 100 with respect to the charging device 23. Thus, in the image forming system 10, the ozone (O) generated from the charging device 23 can be exhausted by the third duct 140.

The image forming system 10 is provided with a plurality of toner image formers 22 for different colors, each including the photoconductor drum 32, the charging device 23, the exposure device 40, and the developing device 38. Each of the plurality of toner image formers 22 is provided with the first duct 100 and the second duct 120. Thus, when the image forming system 10 includes the plurality of toner image formers 22, the exposure device 40 can be cooled with reduced layout space.

### Second Exemplary Embodiment

Next, an image forming system according to a second exemplary embodiment will be described. Note that the same components as those in the first exemplary embodiment described above are labeled with the same symbols, and a description thereof will be omitted.

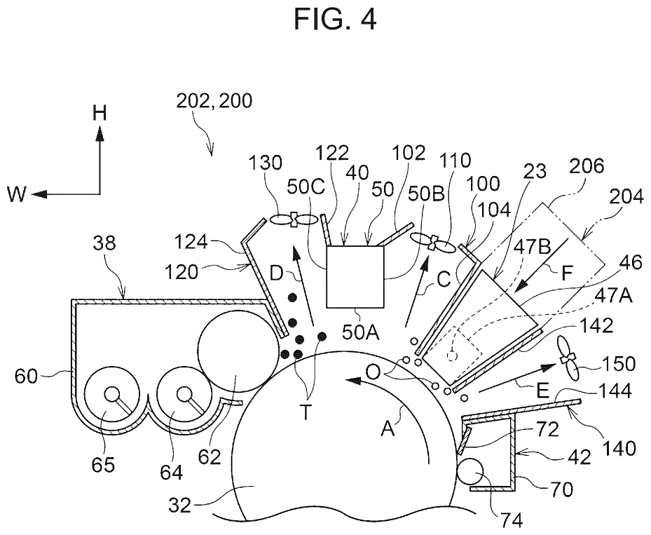

As illustrated in FIG. 4, an image forming system 200 according to the second exemplary embodiment is provided with a toner image former 202 instead of the toner image former 22 of the first exemplary embodiment. The toner image former 202 is an example of an image former.

The toner image former 202 is provided with an air blow mechanism 204 that blows air from a rear position of the charging device 23 to the photoconductor drum 32 in an arrow F direction. The air blow mechanism 204 surrounds the charging device 23, and includes a duct 206 open toward the photoconductor drum 32, and a fan (not illustrated) provided at an axial one end of the photoconductor drum 32 in the duct 206. The duct 206 has a shape opened toward the photoconductor drum 32. As an example, the wall section 104 of the first duct 100 and the wall section 142 of the third duct 140 serve as part of the wall of the duct 206. Note that other components of the image forming system 200 are similar to those of the image forming system 10 of the first exemplary embodiment.

The image forming system 200 of the second exemplary embodiment has the following effects in addition to the effects due to the configuration similar to that of the image forming system 10 of the first exemplary embodiment.

The image forming system 200 of the second exemplary embodiment is provided with the air blow mechanism 204 that blows air from a rear position of the charging device 23 to the photoconductor drum 32 in the arrow F direction. Therefore, in the image forming system 200, the air blown from a rear position of the charging device 23 to the photoconductor drum 32 can be smoothly passed through the first duct 100 by the air blow mechanism 204.

### Third Exemplary Embodiment

Next, an image forming system according to a third exemplary embodiment will be described. Note that the same components as those in the first and second exemplary embodiments described above are labeled with the same symbols, and a description thereof will be omitted.

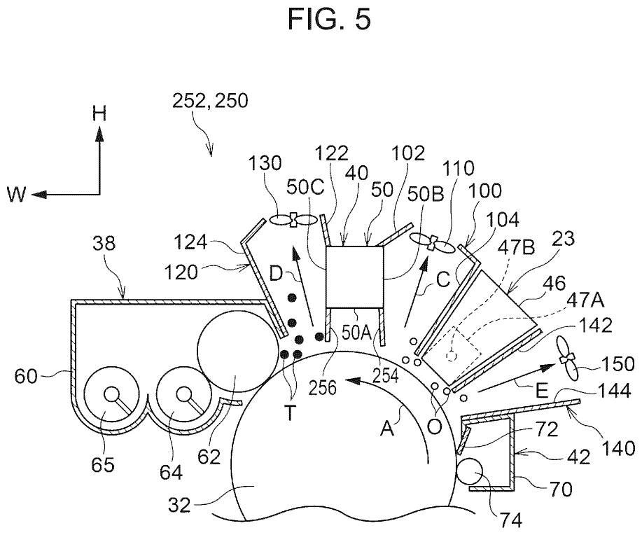

As illustrated in FIG. 5, an image forming system 250 according to the third exemplary embodiment is provided with a toner image former 252 instead of the toner image former 22 of the first exemplary embodiment. The toner image former 252 is an example of an image former.

The toner image former 252 is provided with a first rectifying plate 254 in the lateral surface 50B, closer to the charging device 23, of the exposure device 40. The first rectifying plate 254 extends toward the photoconductor drum 32, and constitutes the wall surface of the first duct 100. As an example, the first rectifying plate 254 extends continuously from the lateral surface 50B of the exposure device 40 in a direction to the photoconductor drum 32. There is a gap between the distal end of the first rectifying plate 254 and the photoconductor drum 32.

In addition, the toner image former 252 is provided with a second rectifying plate 256 in the lateral surface 50C, closer to the developing device 38, of the exposure device 40. The second rectifying plate 256 extends toward the photoconductor drum 32, and constitutes the wall surface of the second duct 120. As an example, the second rectifying plate 256 extends continuously from the lateral surface 50C of the exposure device 40 in a direction to the photoconductor drum 32. There is a gap between the distal end of the second rectifying plate 256 and the photoconductor drum 32. Note that other components of the image forming system 250 are similar to those of the image forming system 10 of the first exemplary embodiment.

The image forming system 250 of the third exemplary embodiment has the following effects in addition to the effects due to the configuration similar to that of the image forming system 10 of the first exemplary embodiment.

The image forming system 250 of the third exemplary embodiment is provided with the first rectifying plate 254 in the lateral surface 50B, closer to the charging device 23, of the exposure device 40. The toner image former 252 is provided with the first rectifying plate 254 in the lateral surface 50B, closer to the charging device 23, of the exposure device 40. The first rectifying plate 254 extends toward the photoconductor drum 32, and constitutes the wall surface of the first duct 100. Thus, in the image forming system 250, adhesion of foreign materials to the exposure device 40 can be reduced, as compared to when the space between the lateral surface, closer to the charging device, of the exposure device, and the photoconductor drum is large.

The image forming system 250 is provided with the second rectifying plate 256 in the lateral surface 50C, closer to the developing device 38, of the exposure device 40. The second rectifying plate 256 extends toward the photoconductor drum 32, and constitutes the wall surface of the second duct 120. Thus, in the image forming system 250, adhesion of foreign materials to the exposure device 40 can be reduced, as compared to when the space between the lateral surface, closer to the developing device, of the exposure device, and the photoconductor drum is large.

### Fourth Exemplary Embodiment

Next, an image forming system according to a fourth exemplary embodiment will be described. Note that the same components as those in the first to third exemplary embodiments described above are labeled with the same symbols, and a description thereof will be omitted.

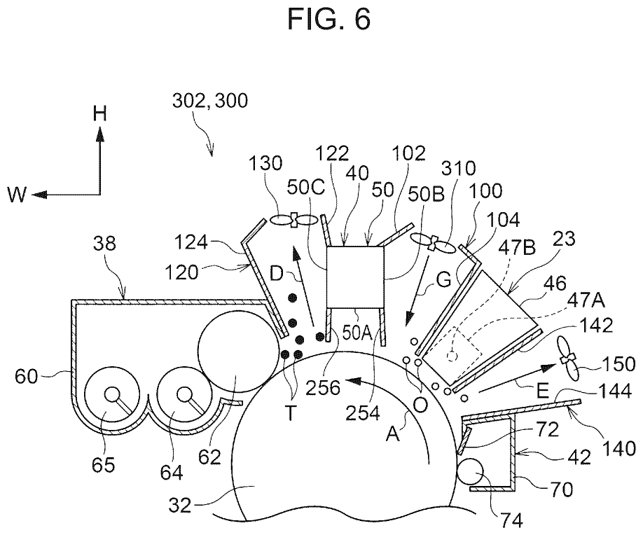

As illustrated in FIG. 6, an image forming system 300 according to the fourth exemplary embodiment is provided with a toner image former 302 instead of the toner image former 22 of the first exemplary embodiment. The toner image former 302 is an example of an image former.

The toner image former 302 is provided with a fan 310 for blowing air in an arrow G direction to the photoconductor drum 32 upstream in the ventilation direction of the first duct 100. The fan 310 is an example of a third air blower. Although illustration is omitted, the fan 310 is provided at one end of the first duct 100 in the axial direction of the photoconductor drum 32. In the fourth exemplary embodiment, the fan 310 is provided instead of the first fan 110 (see FIG. 3) provided at one end of the first duct 100 in the axial direction of the photoconductor drum 32 of the image forming system 10 of the first exemplary embodiment. Inside the first duct 100, the direction (arrow G direction) of air blown by the fan 310 is opposite to the direction of air blown by the first fan 110 of the first exemplary embodiment. Note that other components of the image forming system 300 are similar to those of the image forming system 10 of the first exemplary embodiment.

The image forming system 300 of the fourth exemplary embodiment has the following effects in addition to the effects due to the configuration similar to those of the image forming system 10 of the first exemplary embodiment and the image forming system 250 of the third exemplary embodiment.

In the image forming system 300 of the fourth exemplary embodiment, the fan 310 is provided upstream in the ventilation direction of the first duct 100 to blow air in the arrow G direction to the photoconductor drum 32. Therefore, in the image forming system 300, the air blown by the fan 310 in the first duct 100 to the photoconductor drum 32 can be smoothly guided and exhausted to the third duct 140.

### Supplementary Explanation

The image forming system of the present disclosure is not limited to the image forming system according to the first to fourth exemplary embodiments, and various modifications are possible. For example, the configuration of the developing device 38, and the configuration of the charging device 23 may be changed. Within the scope of the present disclosure, the shape and size of each duct may be changed.

In the first to fourth exemplary embodiments, both the first duct 100 and the second duct 120 are provided, but the present disclosure is not limited to this. For example, in the image forming system, either one of the first duct 100 and the second duct 120 may be provided.

Although specific exemplary embodiments of the present disclosure have been described in detail, the present disclosure is not limited to those exemplary embodiments, and it is apparent to those skilled in the art that various other exemplary embodiments are possible within the scope of the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An image forming system comprising:
a rotatable image carrier;
a charger that is disposed to be opposed to the image carrier, and configured to charge a surface of the image carrier;
a light exposer that is disposed to be opposed to the image carrier downstream of the charger in a rotational direction of the image carrier, and configured to expose the image carrier by transmitting light through a plurality of lenses arranged in an axial direction of the image carrier to form a latent image on the image carrier, the light being emitted from a plurality of light emitting elements; and
a first ventilation pipe that is provided between the charger and the light exposer to construct part of an in-pipe wall surface at a lateral surface of the light exposer, and configured to allow air to pass through the first ventilation pipe, the lateral surface closer to the charger.
   (((2)))

An image forming system comprising:
a rotatable image carrier;
a light exposer that is disposed to be opposed to the image carrier, and configured to expose the image carrier by transmitting light through a plurality of lenses arranged in an axial direction of the image carrier to form a latent image on the image carrier, the light being emitted from a plurality of light emitting elements;
a developing unit that is disposed to be opposed to the image carrier downstream of the light exposer in a rotational direction of the image carrier, and configured to develop the latent image of the image carrier with toner; and
a second ventilation pipe that is provided between the developing unit and the light exposer to construct part of an in-pipe wall surface at a lateral surface of the light exposer, and configured to allow air to pass through the second ventilation pipe, the lateral surface closer to the developing unit.
   (((3)))

The image forming system according to (((1))), further comprising: a first air blower that is provided downstream in a ventilation direction of the first ventilation pipe, and configured to exhaust air in a direction away from the image carrier.

(((4)))

The image forming system according to (((2))), further comprising: a second air blower that is provided downstream in a ventilation direction of the second ventilation pipe, and configured to exhaust air in a direction away from the image carrier.

(((5)))

The image forming system according to (((1))), further comprising:
a third ventilation pipe that is provided on an opposite side of the first ventilation pipe with respect to the charger, and configured to exhaust air in a direction away from the image carrier.
   (((6)))

The image forming system according to (((3))), further comprising: an air blow mechanism that blows air from a rear position of the charger to the image carrier.

(((7)))

The image forming system according to (((1))), further comprising:
a first rectifying plate that is provided on the lateral surface, closer to the charger, of the light exposer, and that extends toward the image carrier and forms a wall surface of the first ventilation pipe.
   (((8)))

The image forming system according to (((2))), further comprising:
a second rectifying plate that is provided on the lateral surface, closer to the developing unit, of the light exposer, and that extends toward the image carrier and forms a wall surface of the second ventilation pipe.
   (((9)))

The image forming system according to (((5))), further comprising:
a third air blower that is provided upstream in a ventilation direction of the first ventilation pipe, and configured to blow air to the image carrier.
   (((10)))

The image forming system according to (((1))), further comprising:
a plurality of image formers for different colors that transfer a toner image formed on the surface of the image carrier to a medium, the plurality of image formers each including the image carrier, the charger, the light exposer, a developing unit that develops a latent image of the image carrier with toner,
wherein each of the plurality of image formers includes the first ventilation pipe.
   (((11)))

The image forming system according to (((2))), further comprising:
a plurality of image formers for different colors that transfer a toner image formed on the surface of the image carrier to a medium, the plurality of image formers each including the image carrier, a charger that charges the surface of the image carrier, the light exposer, and the developing unit,
wherein each of the plurality of image formers includes the second ventilation pipe.

What is claimed is:

1. An image forming system comprising:
a rotatable image carrier;
a charger that is disposed to be opposed to the image carrier, and configured to charge a surface of the image carrier;
a light exposer that is disposed to be opposed to the image carrier downstream of the charger in a rotational direction of the image carrier, and configured to expose the image carrier by transmitting light through a plurality of lenses arranged in an axial direction of the image carrier to form a latent image on the image carrier, the light being emitted from a plurality of light emitting elements; and
a first ventilation pipe that is provided between the charger and the light exposer to construct part of an in-pipe wall surface at a lateral surface of the light exposer, and configured to allow air to pass through the first ventilation pipe, the lateral surface closer to the charger.

2. An image forming system comprising:
a rotatable image carrier;
a light exposer that is disposed to be opposed to the image carrier, and configured to expose the image carrier by transmitting light through a plurality of lenses arranged in an axial direction of the image carrier to form a latent image on the image carrier, the light being emitted from a plurality of light emitting elements;
a developing unit that is disposed to be opposed to the image carrier downstream of the light exposer in a rotational direction of the image carrier, and configured to develop the latent image of the image carrier with toner; and
a second ventilation pipe that is provided between the developing unit and the light exposer to construct part of an in-pipe wall surface at a lateral surface of the light exposer, and configured to allow air to pass through the second ventilation pipe, the lateral surface closer to the developing unit.

3. The image forming system according to claim 1, further comprising:
a first air blower that is provided downstream in a ventilation direction of the first ventilation pipe, and configured to exhaust air in a direction away from the image carrier.

4. The image forming system according to claim 2, further comprising:
a second air blower that is provided downstream in a ventilation direction of the second ventilation pipe, and configured to exhaust air in a direction away from the image carrier.

5. The image forming system according to claim 1, further comprising:
a third ventilation pipe that is provided on an opposite side of the first ventilation pipe with respect to the charger, and configured to exhaust air in a direction away from the image carrier.

6. The image forming system according to claim 3, further comprising:
an air blow mechanism that blows air from a rear position of the charger to the image carrier.

7. The image forming system according to claim 1, further comprising:
a first rectifying plate that is provided on the lateral surface, closer to the charger, of the light exposer, and that extends toward the image carrier and forms a wall surface of the first ventilation pipe.

8. The image forming system according to claim 2, further comprising:
a second rectifying plate that is provided on the lateral surface, closer to the developing unit, of the light exposer, and that extends toward the image carrier and forms a wall surface of the second ventilation pipe.

9. The image forming system according to claim 5, further comprising:
a third air blower that is provided upstream in a ventilation direction of the first ventilation pipe, and configured to blow air to the image carrier.

10. The image forming system according to claim 1, further comprising:
a plurality of image formers for different colors that transfer a toner image formed on the surface of the image carrier to a medium, the plurality of image formers each including the image carrier, the charger, the light exposer, a developing unit that develops a latent image of the image carrier with toner,
wherein each of the plurality of image formers includes the first ventilation pipe.

11. The image forming system according to claim 2, further comprising:
a plurality of image formers for different colors that transfer a toner image formed on the surface of the image carrier to a medium, the plurality of image formers each including the image carrier, a charger that charges the surface of the image carrier, the light exposer, and the developing unit,
wherein each of the plurality of image formers includes the second ventilation pipe.

12. An image forming system comprising:
rotatable image carrying means;
charging means, disposed to be opposed to the image carrying means, for charging a surface of the image carrying means;
light exposing means, disposed to be opposed to the image carrying means downstream of the charging means in a rotational direction of the image carrying means, for exposing the image carrying means by transmitting light through a plurality of lenses arranged in an axial direction of the image carrying means to form a latent image on the image carrying means, the light being emitted from a plurality of light emitting elements; and
first ventilation means, provided between the charging means and the light exposing means to construct part of an in-pipe wall surface at a lateral surface of the light exposing means, for allowing air to pass through the first ventilation means, the lateral surface closer to the charging means.
